(19) United States
(12) Patent Application Publication
(10) Pub. No.: US 2005/0024430 A1
(43) Pub. Date: Feb. 3, 2005

(54) Printer profile mapping of input primaries to output primaries

(76) Inventor: William C. Kress, Vista, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/619,388

(22) Filed: Jul. 14, 2003

(51) Int. Cl. B41J 2/21

(52) U.S. Cl. 347/43

(57) ABSTRACT

A method for printing outside the gamut by anticipating where monitor primaries will map and the placement of desired printer primaries at that place. A relationship is established between a printer (B2Ax) profile that anticipates the input (A2Bx) profile and maps them in a simplistic manner. The mapping is used to create an output ICC profile (B2Ax) mapping that includes mappings for colors out of the gamut. First, the most important color mappings (RGBCMY, etc.) are established and these mappings are then used to determine the outside the gamut properties of the ICC output transform. The inside the gamut transforms remain the same as classic rendering. Another aspect of the present invention is to make run-time changes to the printer profile to map the image input primaries to optimal output primaries, thus enabling a printer to be mapped for several different types of monitors or input primaries.

### BACKGROUND OF THE INVENTION

The present invention is generally related to image output devices and more specifically to mapping input primaries that are outside the scope of the image output device's ability to reproduce.

The International Color Consortium (ICC) defines device profiles to provide color management systems with the information necessary to convert color data between native device color spaces and device independent color spaces. The specification divides color devices into three broad classifications: input devices, display devices and output devices. For each device class, a series of base algorithmic models are described which perform the transformation between color spaces. These models provide a range of color quality and performance results, which provide different trade-offs in memory footprint, performance and image quality.

In general, actual device color gamuts (the range of all possible colors which can be represented or produced on the device) may not be large enough to reproduce the desired color appearances communicated by the PCS values. Four rendering intents (gamut mapping styles) are defined by the ICC in order to address this problem. Each one represents a different compromise. The calorimetric rendering intents enable within gamut colors to be reproduced accurately (though possibly with compensation for the whiteness of the media) at the expense of out-of-gamut colors. Compensation can be made for chromatic adaptation when the viewing condition assumed is different to the reference viewing environment. The other rendering intents modify the calorimetric values as-needed to account for any differences between devices, media, and viewing conditions.

One shortcoming of ICC specification is the specification of how source colors outside the destination color gamut should be mapped. This is particularly problematic when mapping input primaries, such as monitors, digital cameras or scanners to output devices such as printers.

For example, one problem is to map monitor primaries to desired printer output. It is not a simple task to match monitor primaries with printer primaries because the monitor Red-Green-Blue (RGB) primaries are quite far outside the printer gamut because the printer gamut.

Thus a need exists for a method to map image input devices to image output devices when the input devices have primaries outside the gamut of the output device. Furthermore, because it is often desired to share image output devices amongst a plurality of image input devices, wherein the image input devices may have different primaries, it is also desired that the image output device have the capability to map image input primaries from a plurality of different image input devices.

### BRIEF SUMMARY OF THE INVENTION

In view of the aforementioned needs, the invention contemplates using a transformation table wherein standard rendering is used for colors inside the gamut, and colors outside the gamut or mapped to a placement of desired printer primaries. The relationship is established by experimentally determining the desired relationship between an input primary and an output primary and mapping the input primary to the desired output primary. Then an output of gamut primary is mapped to a placement of desired printer primaries. The mappings may then be used to create a transformation table.

After the transformation table is established, when the image output device receives an image input from an image input device, which comprises colors inside the gamut and outside the gamut, the image output is created by converting the image colors to output colors via the transformation table.

Another aspect of the invention contemplates using a plurality of transformation tables wherein each transformation table is mapped to an image input profile. This enables the image output device to support a plurality of image input profiles. Then when the image output device receives an image, the proper profile for the image input is determined and the appropriate transformation table is selected for converting the input image.

The present invention further contemplates an apparatus and computer readable medium for performing the aforementioned methods.

While it is contemplated that the present invention will frequently be implemented using software, the present invention may be implemented in hardware, software or a combination thereof. Furthermore, the present invention may be implemented within the output device, on a server or some interface between the input device and the output device, or even at the input device, for example by a printer driver on the input device.

Still other objects of the present invention will become readily apparent to those skilled in this art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE SEVERAL VIEWS OF THE DRAWING

The accompanying drawings incorporated in and forming a part of the specification, illustrates several aspects of the present invention, and together with the description serve to explain the principles of the invention. In the drawings:

FIG. 1 is a block diagram illustrating a simple connection between a monitor and a printer;

FIG. 2 is a block diagram of an embodiment of the present invention wherein primaries from a single image input device is mapped to an image output device; and

FIG. 3 is a block diagram of an embodiment of the present invention wherein the image output device is capable of translating primaries from a plurality of different image input devices.

### DETAILED DESCRIPTION OF INVENTION

Throughout this description, the preferred embodiment and examples shown should be considered as exemplars, rather than limitations, of the present invention.

The present invention contemplates the construction of profiles so that mapping of monitor primaries to desired printer output is optimized.

One aspect of the present invention is directed to printing outside the gamut by anticipating where monitor primaries will map and the placement of desired printer primaries at that place. There are a small number of frequently used monitor primaries, such as RGB, sRGB and Adobe RGB, etc., thus the present invention may be easily implemented for a variety of monitors. Display primaries (RGB) and secondaries (CMY) are known. Similarly, printer primaries and secondaries are known. One aspect of the present invention establishes a relationship within a printer (B2Ax) profile that anticipates the input (A2Bx) profile and provides a mapping in an optimal manner. For example, the typical printer cannot print red 255,0,0 but instead must use a combination of magenta and yellow. However, the appropriate combination of magenta and yellow is dependent upon the output device. The desired mapping is used to create an output ICC profile (B2Ax) mapping that includes mappings for colors out of the gamut.

First, the most important color mappings (RGBCMY, etc.) are established and these mappings are then used to determine the outside the gamut properties of the ICC output transform. The inside the gamut transforms remain the same as classic rendering, except for necessary blending or smoothing needed to eliminate contours.

Another aspect of the present invention is to make run-time changes to the printer profile to map the image input primaries to optimal output primaries. The input-output mapping strategy instructions are printer specific and can be included in a printer profile private tag.

Display primaries (RGB) are known for any input profile. This is tag information and can be easily calculated. The mapping strategy of input to printer can be experimentally determined and specified for any specific printer and mode (perceptual, saturation, colorimetric). The relationship between display and printer primaries are therefore established and can be used to change the output ICC profile (B2Ax).

As can be appreciated, a very large monitor profile (e.g. “Big RGB”) will have a different mapping than that of a small monitor profile such as sRGB. By making the mapping between the monitor and the printer dependent upon knowledge of the specific input profile, consistent and optimal color output can be obtained.

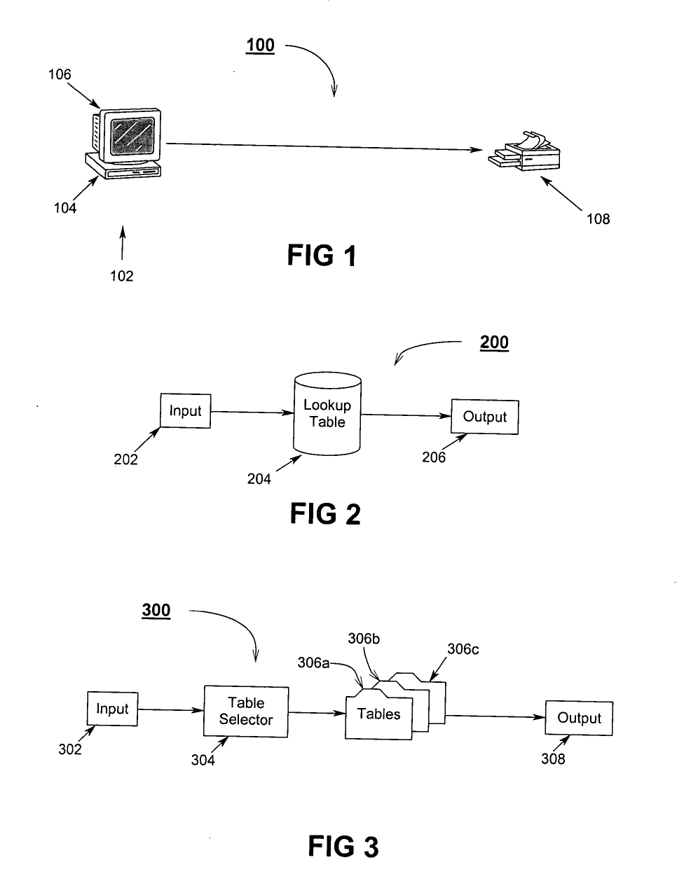

Referring now to FIG. 1 there is shown a typical system 100, wherein an image input device 102, as shown in this embodiment a computer 104 with a central processing unit and memory, and a display monitor 106. The image input device 102 can also be any device capable of producing or receiving images such as a scanner or digital camera.

Referring to FIG. 2 there is shown a block diagram illustrating an embodiment 200 contemplated by the present invention. An image is received by the printer at input 202. The image comprises colors that are within and outside of the image output device's gamut. The image is then processed using lookup table 204 wherein the colors are converted or mapped to the output device's colors, creating an output 206.

Referring now to FIG. 3 there is shown a block diagram of an alternative embodiment 300 of the present invention. An image with colors inside and outside the printer's gamut input is received at 302. A table selector then determines the image's input source and selects the appropriate transformation tables 306a, 306b and 306c. The image is then converted to the output as shown at 308.

The embodiments 200 and 300 above describe the image transformation process as occurring at the printer, however, the image transformation may occur prior to reaching the printer. For example, a printer driver at the image input device 102 may perform the transformation prior to sending the print job to the printer. The image transformation may occur at a location remote from both the image input device 102 and the printer 108. For example in a networked environment a separate controller or processor may be used for handling print jobs to printer 108.

While the detailed description hereinabove describes the interaction between monitors and printers, as those skilled in the art can readily appreciate the concepts of the present invention are applicable to other image input devices including but not limited to digital cameras and scanners and other image output devices including but not limited to copiers and facsimile machines.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of the ordinary skill in the art to utilize the invention in various embodiments and with various modifications as are suited to the particular use contemplated. All such modifications and variations are within the scope of the invention as determined by the appended claims when interpreted in accordance to the breadth to which they are fairly, legally and equitably entitled.

1. A method for printing colors outside the gamut of an image output device, comprising the steps of:
experimentally determining a relationship between an input primary and an output primary;
mapping the input primary to an output primary;
mapping an output of gamut primary to a placement of desired printer primaries.

2. The method of claim 1 further comprising combining the mapping of the out of gamut primary with an inside the gamut profile.

3. The method of claim 1 further comprising creating a transformation table, the transformation table comprising an inside the gamut profile and the mapping an output of gamut primary to a placement of desired printer primaries.

4. The method of claim 3, the steps further comprising:
receiving an image input from an image input device, the image comprising colors inside the gamut and outside the gamut; and
converting the image colors to output colors via the transformation table.

5. The method of claim 3 wherein a plurality of transformation tables are created, each transformation table is mapped to an image input profile.

6. The method of claim 5, the steps further comprising:
receiving an image input from an image input device, the image comprising colors inside the gamut and outside the gamut;
determining a profile for the image input;
selecting one of the plurality of transformation tables that matches the profile; and
converting the image colors to output colors via the transformation table.

7. The method of claim 1 wherein the image output device has a mode selected from the group consisting of perceptual, saturation and calorimetric.

8. An apparatus for mapping an image input profile to an image output device, comprising:
means adapted to experimentally determine a relationship between an input primary and an output primary;
means adapted to map the input primary to an output primary;
means adapted to map an output of gamut primary to a placement of desired printer primaries.

9. The apparatus of claim 8 further comprising means adapted to combine the mapping of the out of gamut primary with an inside the gamut profile.

10. The apparatus of claim 8 further comprising means adapted to create a transformation table, the transformation table comprising an inside the gamut profile and the mapping an out of gamut primary to a placement of desired printer primaries.

11. The apparatus of claim 10 further comprising:
means adapted to receive an image input from an image input device, the image comprising colors inside the gamut and outside the gamut; and
means adapted to converting the image colors to output colors via the transformation table.

12. The apparatus of claim 10 wherein a plurality of transformation tables are created, each transformation table is mapped to an image input profile.

13. The apparatus of claim 12 further comprising:
means adapted to receive an image input from an image input device, the image comprising colors inside the gamut and outside the gamut;
means adapted to determine a profile for the image input;
means adapted to select one of the plurality of transformation tables that matches the profile; and
means adapted to convert the image colors to output colors via the transformation table.

14. A computer readable medium of instructions having computer readable code encoded thereon for mapping an image input profile to an image output device, comprising:
means adapted to experimentally determine a relationship between an input primary and an output primary;
means adapted to map the input primary to an output primary;
means adapted to map an output of gamut primary to a placement of desired printer primaries.

15. The computer readable medium of claim 14 further comprising means adapted to combine the mapping of the out of gamut primary with an inside the gamut profile.

16. The computer readable medium of claim 14 further comprising means adapted to create a transformation table, the transformation table comprising an inside the gamut profile and the mapping an output of gamut primary to a placement of desired printer primaries.

17. The computer readable medium of claim 16, further comprising:
means adapted to receive an image input from an image input device, the image comprising colors inside the gamut and outside the gamut; and
means adapted to converting the image colors to output colors via the transformation table.

18. The computer readable medium of claim 10 wherein a plurality of transformation tables are created, each transformation table is mapped to an image input profile.

19. The computer readable medium of claim 18 further comprising:
means adapted to receive an image input from an image input device, the image comprising colors inside the gamut and outside the gamut;
means adapted to determine a profile for the image input;
means adapted to select one of the plurality of transformation tables that matches the profile; and
means adapted to convert the image colors to output colors via the transformation table.

20. An image output apparatus, comprising:
means adapted to communicate with a transformation table, the transformation table comprising means adapted to map an input primary to an output primary and means adapted to map an out of gamut primary to a placement of desired printer primaries;
means for receiving an image comprising a plurality of colors from an image input device;
wherein an output image is created by transforming the plurality of colors from the input image device via the transformation table and at least one of the plurality of colors is outside the image output device's gamut.

21. The apparatus of claim 20 wherein the image input device is selected from the group consisting of a monitor, a scanner, and a digital camera.

22. The apparatus of claim 20 wherein the means to communicate comprises means to communicate to a plurality of transformation tables, further comprising:
means adapted to determine an input profile; and
means adapted to select an appropriate transformation table from the transformation table based on the input profile.
